(19) United States
(12) Patent Application Publication
(10) Pub. No.: US 2014/0224063 A1
(43) Pub. Date: Aug. 14, 2014

(54) DOWNHOLE ASSEMBLY WITH MAGNETIC GEARBOX

(71) Applicants: Adrian Alford, Twyford Berkshire (GB); Julian Reed, Haslemere Surrey (GB); Kar Ship, Southampton Hampshire (GB)

(72) Inventors: Adrian Alford, Twyford Berkshire (GB); Julian Reed, Haslemere Surrey (GB); Kar Ship, Southampton Hampshire (GB)

(73) Assignee: Corac Energy Technologies Limited, Berkshire (GB)

(21) Appl. No.: 14/112,658

(22) PCT Filed: Mar. 30, 2012
(86) PCT No.: PCT/IB12/51568

§ 371 Date: Mar. 24, 2014

(30) Foreign Application Priority Data
Apr. 20, 2011 (GB) 1106666.9

(51) Int. Cl. F16H 57/021

(52) U.S. Cl. CPC F16H 57/021
USPC 74/606 R

(57) ABSTRACT

A magnetic change speed gearbox his described for use in a downhole assemblies having a higher speed shaft supported by a gas bearing. The downhole assembly may be one comprising a motor driving a compressor by way of a step-up magnetic gearbox or one comprising a gas turbine driving a pump by way of a step-down magnetic gearbox.

### FIELD OF THE INVENTION

The present invention relates to a magnetic gearbox.

### BACKGROUND OF THE INVENTION

The term “magnetic gearbox” is used herein to refer to any change speed gearbox in which an input shaft is coupled magnetically for rotation with an output shaft without the need for any physical contact between the two, the torque driving the output shaft being magnetically generated.

Such a gearbox has been proposed by Magnomatics Limited which comprises two rings carrying permanent magnets and an intermediate ring carrying non-magnetised pole pieces. An example of such a gearbox is to be found in GB 2457682.

The interior of a magnetic gearbox does not require lubrication as it has no contacting parts. The three rings are spaced from one another by air gaps and they do not rub against one another. However, the input and output shafts in existing applications of such gearboxes have been supported in conventional friction or anti-friction bearings, and such bearings do require oil lubrication.

### SUMMARY OF THE INVENTION

The present invention in its broadest aspect provides a magnetic change speed gearbox having a higher speed shaft supported by a gas bearing. The term “higher speed” is used in this context to mean whichever of the input and output shafts rotates at the higher speed during use. In a step-up gearbox, the output shaft would be the higher speed shaft but in a step-down gearbox it is the input shaft that acts as the higher speed shaft.

For some applications, it is advantageous for the gearbox lower speed shaft to be liquid lubricated. In this context, the term “lower speed shaft” refers to the other of the input and output shafts that rotates at the lower speed during use.

In the field of extracting gas from wells, it has been proposed to lower into a well a compressor driven by a three phase motor, in particular a permanent magnet motor. Such a motor can be connected directly to a compressor or it may be connected by a change speed gearbox to the compressor.

If no gearbox is used, the motor has to be operated at high speed and that has created certain problems. In particular, the control circuitry for a high speed motor needs to be located next to the motor. This is in order to avoid problems created by transmitting high frequency signals between the motor and controller mounted above ground level. It is however difficult to construct electrical circuits than can operate reliably in such a hostile physical environment.

The alternative solution of using a low speed motor and a step-up gearbox allows the controller to be mounted above ground as only low frequency signals pass between the controller and the motor. However, a gearbox is now needed that can perform reliably in the down hole environment and hitherto lubrication of the gearbox has presented a problem.

It should be born in mind in this context that gas production needs to be stopped while a compressor is being manoeuvred into the well and this may take several days. Because of the resultant very high cost of this operation, it is imperative for the electrically driven compressor to be able to operate reliably for prolonged periods without any maintenance.

The present invention recognises that a magnetic gearbox offers a possible solution to this problem. The combination of a motor, a magnetic gearbox and a compressor overcomes all the problems encountered previously in that the motor can be controlled from above ground. The input shaft of the magnetic gearbox can be supported on a permanently sealed roller bearing while the output shaft can be reliably lubricated using the production gas.

Thus, in a further aspect of the invention, there is provided an assembly for lowering into a gas well, comprising an electric motor connected to a gas compressor by way of a change speed magnetic gearbox, wherein the output shaft of the gearbox connected to the compressor is supported by a gas bearing.

The gas bearing may either form part of the gearbox or part of the compressor. The location of the gas bearing and its construction are not material to the invention so long as a ring of magnets within the magnetic gearbox that rotates with the rotor of the compressor is stably supported in correct alignment with the intermediate ring of the gearbox carrying the pole pieces.

In the preferred embodiment of the invention, the speed of the electric motor of the assembly is controlled by a controller located in use remotely from the motor above ground level and connected to the motor by a transmission line.

In the application described above, the higher speed shaft of the gearbox is its output shaft but this need not necessarily always be the case.

It may also be beneficial to incorporate a quill shaft between the output shaft of the magnetic gearbox and the compressor, in order to minimise any misalignment or rotordynamic effects of either assembly influencing the behaviour of the other. In this case, the output shaft of the magnetic gearbox may be supported on two gas bearing assemblies, one supported from the intermediate ring of the gearbox carrying the pole pieces.

A magnetic gearbox with a high speed shaft support by a gas bearing may also be used in a system where gas lift is currently used to accelerate the flow of oil to the surface. In such a system, gas is compressed and fed to the base of the well. The upwards flow and expansion of the gas as it approaches the surface entrains oil which otherwise would flow at a much slower rate, either due to the oil's high viscosity or low original well pressure. The combination of both oil and gas effectively reduces the density of this two phase flow and reduces the effective static head in the well, promoting further oil flow. The use of a step-down magnetic gearbox in such a system allows the use of a pump driven by a gas expansion turbine powered by the compressed gas. The gas fed to the base of the well has sufficient excess pressure (over and above the static head of the oil) to also drive a turbine which in turn drives a pump to increase the oil pressure in the oil well.

Here a step-down gearbox is needed as the gas expansion turbine operates at a higher speed than the oil pump and the magnetic gearbox of the present invention is capable to fulfilling this function reliably as it has no parts that are prone to wear.

### BRIEF DESCRIPTION OF THE DRAWINGS

The invention will now be described further, by way of example, with reference to the accompanying drawings, in which :

FIG. 1 shows a downhole compressor driven by an electric motor by way of a magnetic gearbox,

FIG. 2 shows an embodiment of the invention similar to that of FIG. 1 in which the motor and the compressor are mounted within the same casing,

FIG. 3 shows a modification of the embodiment shown in FIG. 2,

FIG. 4 shows a further modification of the arrangement in FIG. 2 where a quill shaft is introduced between the compressor shaft and the output shaft of the magnetic gearbox, and

FIG. 5 shows an embodiment of the invention in which a compressed air driven expansion turbine is connected to drive a liquid pump.

### DETAILED DESCRIPTION OF THE PREFERRED EMBODIMENTS

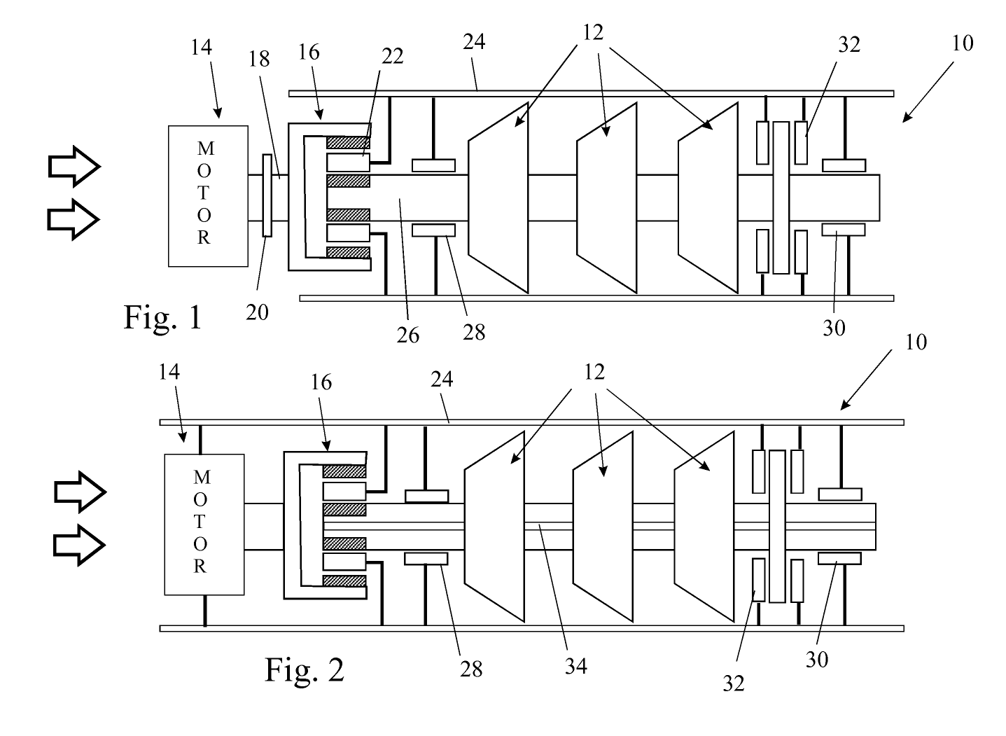

In FIG. 1, there is shown an assembly for lowering into a gas well to assist in gas extraction. The assembly 10 comprises a three stage compressor 12 arranged within the flow path of the production gas represented by two arrows at the left of the drawing. The compressor 12 is driven by an electric motor 14 which receives power and control signals from a control unit located above ground outside the well. Because of the difficulty in sending high-frequency signals to the motor 14 if the latter were a high-speed motor, a low speed motor is used instead and is connected to the compressor 12 by way of a gearbox 16.

A downhole assembly consisting of a turbine driven by an electric motor by way of a gearbox has previously been proposed but in the prior art the gearbox used was an oil lubricated mechanical gearbox. This proposal was not practical as the gearbox could not be serviced at regular intervals without bringing the production of the well to a standstill.

In the present invention, the mechanical gearbox is replaced by a magnetic gearbox as described for example in GB 2457682. Such a gearbox comprises an input shaft and a concentric output shaft both of which carry an array of permanent magnets. The two arrays of magnets are separated from one another by an intermediate ring comprising an array of pole pieces. If the intermediate ring is held stationary while the array of magnets connected to the input shaft is rotated at low speed, then the output shaft connected to the inner array of magnets rotates at high speed. The geometry of the permanent magnets and pole pieces determines the gearing ratio.

Because an air gap exists between the pole pieces and the two arrays of permanent magnets, the internal parts of a magnetic gearbox do not require lubrication. Nevertheless, the input shaft and the output shaft do still need to be supported in suitable bearings requiring lubrication. To avoid the need for regular servicing, the present invention proposes using a gas lubricated bearing to support the high-speed shaft. The low speed shaft does not pose a problem as it may be supported by means of a rolling bearing or a friction bearing that is permanently sealed and filled with a lubricant such as oil or grease.

In FIG. 1, the gearbox 16 has an input shaft 18 connected by way of a coupling 20 to the output shaft of the motor 14. The ring of pole pieces 22 is connected to a housing 24 of the three stage compressor 12, while the inner array of magnets is mounted directly on the rotor 26 of the compressor 12. The rotor 26 of the compressor 12 is supported by two gas bearings 28 and 30 arranged one at each end of the rotor. To locate the rotor 26 axially, there is provided a gas lubricated axial thrust bearing 32.

It is thus seen that in FIG. 1 both the input and output shafts of the gearbox 16 are suitably supported and no other steps are required to lubricate the gearbox 16 as its shafts and ring of pole pieces are not in physical contact with one another.

Because the gaps between the components of the magnetic gearbox have to be maintained within close tolerance, the motor 14 needs to be accurately located permanently in relation to the compressor 12. This is achieved in FIG. 2 in that the motor 14 is mounted to the same casing 24 as the compressor 12 and the two can be lowered as a unitary assembly into the gas well after they have been suitably aligned.

The embodiment of FIG. 2 also differs from that of FIG. 1 also by the provision of an axial bore 34 that extends over the length of the rotor 26. This bore connects the high-pressure end of the compressor 12 to the interior of the magnetic gearbox 16 which is at a lower pressure. As a result, production gas is forced through the magnetic gearbox 16 and serves to cool the components of the gearbox and the hydrostatic pressure serves to maintain the desired separation between them.

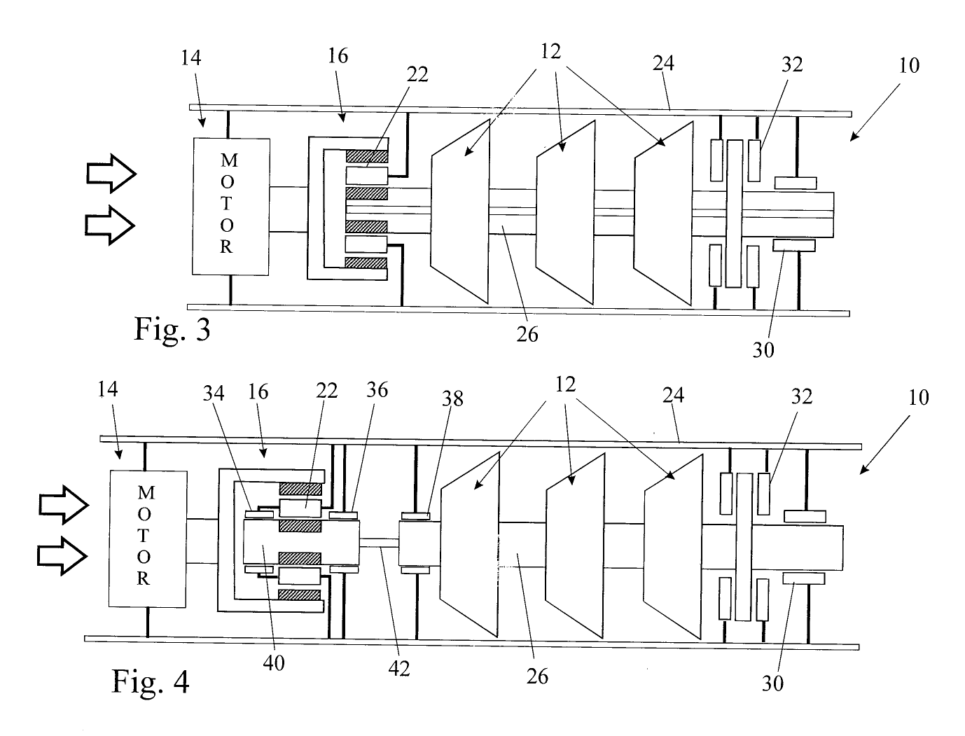

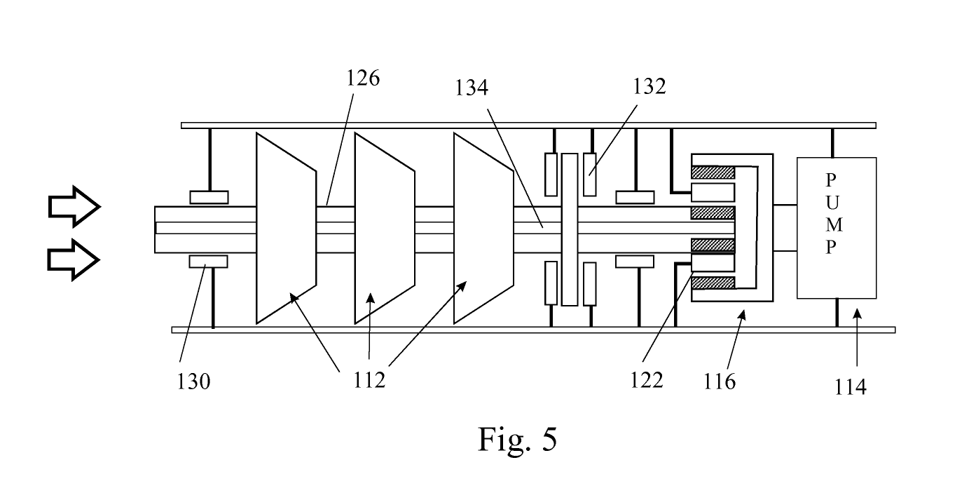

The embodiment of FIG. 3 differs from that of FIG. 2 by the omission of the gas bearing 28. In this case, the pole piece ring 22 of the magnetic gearbox 16 doubles as a gas bearing serving to support the end of the rotor 26 of the compressor 12.

The embodiment of FIG. 4 differs from that in FIG. 3 by the introduction of a quill shaft 42 between the compressor shaft 26 and the output shaft 40 of the magnetic gearbox 16 and the incorporation of two further gas bearings 34 and 36 supporting the magnetic gearbox output shaft 40. The gas bearing 34 is arranged within the envelope of the magnetic gearbox and is supported by the intermediate ring carrying the stationary pole pieces 22.

As earlier described, it has also been proposed in the field of oil exploration to feed compressed gas into the well as a means of assisting transportation of the oil to the surface. When a compressed gas is used to assist in oil extraction, there is sufficient energy in the gas to operate a pump serving to increase the pressure of the oil.

The embodiment of the invention shown in FIG. 4 uses a gas driven turbine 112 to drive a pump 114 by way of a magnetic gearbox 116. This arrangement is essentially a mirror image of the embodiment shown in FIG. 2 with the direction of the forces acting in reverse. To avoid unnecessary repetition, components serving a function analogous to components previously described have been allocated the same reference numerals but in the 100 series.

Because of the reversal of the forces, the high-speed shaft of the gearbox 116 now acts as the input shaft to the gearbox 116 whereas the lower speed shaft 118 as the input shaft driving the pump 114. In view of the symmetry, it is believed that the operation of this embodiment will be clear to the person skilled in the art without the need for more detailed explanation.

1. A magnetic change speed gearbox for connection between an electric motor and a gas compressor, the magnetic change speed gearbox having a higher speed output shaft supported by a gas bearing, said output shaft being for connection to the gas compressor.

2. The magnetic change speed gearbox as claimed in claim 1, wherein a lower speed input shaft of the gearbox is liquid lubricated.

3. The magnetic change speed gearbox as claimed in claim 1, wherein input and output shafts of the magnetic gearbox are magnetically connected to one another by way of two rings carrying permanent magnets and an intermediate ring carrying non-magnetised pole pieces in such a manner that the input and output shafts rotate with a fixed speed ratio.

4. The magnetic change speed gearbox as claimed in claim 1, being for lowering into a gas well.

5. An assembly for lowering into a gas well, comprising an electric motor connected to a gas compressor by way of a change speed magnetic gearbox, the magnetic change speed gearbox having a higher speed output shaft supported by a gas bearing, said output shaft being connected to the gas compressor.

6. The assembly as claimed in claim 5 wherein the gas bearing forms part of the magnetic gearbox.

7. The assembly as claimed in claim 5 wherein the gas bearing forms part of the compressor.

8. The assembly as claimed in claim 5, wherein the speed of the electric motor is controlled by a controller located in use remotely from the motor above ground level and connected to the motor by a transmission line.

9. The assembly as claimed in claim 5, wherein a bore is provided in a rotor of the compressor to connect a high pressure side of the compressor to the interior of the magnetic gearbox.

10. The assembly as claimed in claim 5, wherein the higher speed output shaft of the magnetic gearbox is connected to a rotor shaft of the gas compressor by means of a quill shaft, and wherein the higher speed output shaft of the magnetic gearbox is supported on two gas bearings, one of which is supported by an intermediate ring of the magnetic gearbox assembly carrying stationary pole pieces.

11. An assembly for lowering into an oil well in which transportation of oil to the surface is assisted by feeding a compressed gas down the well, comprising a gas expansion turbine powered by the compressed gas and a pump driven by the gas turbine for increasing the oil pressure in the well, wherein the gas turbine is connected to the pump by a magnetic gearbox of which the input shaft connected to the gas turbine is supported by a gas bearing.

12. The assembly as claimed in claim 11, wherein the gas bearing forms part of the magnetic gearbox.

13. The assembly as claimed in claim 11 wherein one gas bearing assembly is within the envelope of the magnetic gearbox.

14. The assembly as claimed in claim 11, wherein the gas bearing forms part of the gas turbine.

15. The assembly as claimed in claim 11, wherein a bore is provided in the rotor of the gas turbine to connect the high pressure side of the gas turbine to the interior of the magnetic gearbox.
